(19) United States
(12) Patent Application Publication
(10) Pub. No.: US 2024/0069306 A1
(43) Pub. Date: Feb. 29, 2024

(54) CAMERA MODULE

(71) Applicant: SAMSUNG ELECTRO-MECHANICS CO., LTD., Suwon-si (KR)

(72) Inventors: Ah Hyeon IM, Suwon-si (KR); Jun Sup SHIN, Suwon-si (KR); Dong Yeon SHIN, Suwon-si (KR)

(73) Assignee: SAMSUNG ELECTRO-MECHANICS CO., LTD., Suwon-si (KR)

(21) Appl. No.: 18/101,619

(22) Filed: Jan. 26, 2023

(30) Foreign Application Priority Data
Aug. 25, 2022 (KR) 10-2022-0107066

(51) Int. Cl. G02B 7/182; G02B 13/00; G02B 27/64; G03B 30/00

(52) U.S. Cl. CPC G02B 7/182; G02B 13/0065; G02B 27/646; G03B 30/00

(57) ABSTRACT

A camera module includes a housing defining an internal space, a lens module including a plurality of lenses, a reflective module disposed in front of the lens module and including a reflective member to change an optical path of light, a first driving unit to rotate the reflective module and including a first coil and a first magnet, a second driving unit to rotate the reflective module and including a second coil and a second magnet, a main substrate attached to the housing and including a first side substrate, and a circuit element disposed on the main substrate to provide a driving signal. The first coil and the second coil are disposed on the first side substrate of the main substrate, and the circuit element is disposed on a surface of the main substrate that is perpendicular to the first side substrate and faces the internal space of the housing.

### CROSS-REFERENCE TO RELATED APPLICATION(S)

This application claims the benefit under 35 USC 119(a) of priority to Korean Patent Application No. 10-2022-0107066 filed on Aug. 25, 2022 in the Korean Intellectual Property Office, the entire disclosure of which is incorporated herein by reference for all purposes.

### BACKGROUND

### 1. Field

The following description relates to a camera module.

### 2. Description of Background

Cameras have been basically adopted for use in portable electronic devices, such as smartphones, tablet PCs, and laptops, and cameras for mobile terminals have been equipped with an autofocusing (AF) function, an optical image stabilization (OIS) function, and a zoom function.

However, camera modules may be complicated and increased in size in order to implement various functions, so that the size of the portable electronic devices on which the camera module is mounted may also be increased.

In addition, when a lens or image sensor is directly moved for hand-shake correction, a weight of the lens or image sensor itself and a weight of other members to which the lens or image sensor is attached must all be considered, a certain level of driving force or higher is required and power consumption is increased.

In addition, in order to implement the AF function and the zoom function, a distance greater than a predetermined length has to be secured so that a plurality of lens barrels may move a long stroke in an optical axis direction and alignment of the optical axes of the plurality of lens barrels should not be disturbed, but it is difficult to implement such a structure in a very small and compact camera structure.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

A camera module which is compact, while implementing functions, such as an autofocusing (AF) function, a zoom function, an optical image stabilization (OIS) function.

In one general aspect, a camera module includes a housing defining an internal space, a lens module including a plurality of lenses disposed along an optical axis, a reflective module disposed in front of the lens module and including a reflective member configured to change an optical path of light, a first driving unit configured to rotate the reflective module and including a first coil and a first magnet, a second driving unit configured to rotate the reflective module and including a second coil and a second magnet, a main substrate attached to the housing and including a first side substrate, and a circuit element disposed on the main substrate and configured to provide a driving signal. The first coil and the second coil are disposed on the first side substrate of the main substrate, and the circuit element is disposed on a surface of the main substrate that is perpendicular to the first side substrate and faces the internal space of the housing.

The circuit element may be disposed to face the reflective module.

The circuit element may include a plurality of circuit elements.

The camera module may include a third driving unit including a third coil and a third magnet configured to drive the lens module, the third coil may be disposed on the first side substrate, and the lens module may include a first lens barrel and a second lens barrel.

The camera module may include a plurality of shafts coupled to the housing and disposed along the optical axis direction, and the first lens barrel may be configured to move in the optical axis direction along the shafts.

The camera module may include a guide ball member disposed between the shafts and the second lens barrel, and the guide ball member may be configured to move in a rolling manner between the plurality of shafts.

The second lens barrel may be coupled to the first lens barrel and may be configured to be integrally movable with the first lens barrel.

The camera module may include a rolling ball member disposed between the first lens barrel and the second lens barrel, and the second lens barrel may be movable above the first lens barrel along the rolling ball member.

The main substrate may include a bottom substrate having a surface parallel to the optical axis, and the circuit element may be disposed on the bottom substrate.

The circuit element may include a plurality of circuit elements, and the plurality of circuit elements may be symmetrical with respect to a center of the bottom substrate.

The main substrate may include a second side substrate having a surface perpendicular to the optical axis, and the circuit element may be disposed on the second side substrate.

The circuit element may include a plurality of circuit elements, and the plurality of circuit elements may be symmetrical with respect to a center of the second side substrate.

In another general aspect, a camera module includes a housing, a lens module disposed in the housing and including a plurality of lenses arranged along an optical axis, a reflective module disposed in front of the lens module and including a reflective member configured to change an optical path of light, a main substrate attached to the housing, and a circuit element disposed on the main substrate and configured to provide a driving signal. The circuit element is disposed to face the reflective module, and the housing has a through-hole corresponding to the circuit element.

The circuit element may be disposed perpendicular to the optical axis.

The circuit element may include a plurality of circuit elements.

Other features and aspects will be apparent from the following detailed description, the drawings, and the claims.

### BRIEF DESCRIPTION OF DRAWINGS

FIG. 1 is a perspective view of a portable electronic device equipped with a camera module according to an example.

FIG. 2 is a schematic perspective view of a camera module according to an example.

FIG. 3A is a cross-sectional view taken along line I-I′ of FIG. 2.

FIG. 3B is a cross-sectional view taken along line II-II′ of FIG. 2.

FIG. 4 is a perspective view of a main substrate including a bottom substrate provided in a camera module according to an example.

FIG. 5 is a perspective view of a main substrate including a second side substrate provided in a camera module according to an example.

FIG. 6 is an exploded perspective view of a camera module including a main substrate including a bottom substrate according to an example.

FIG. 7 is an exploded perspective view of a camera module including a main substrate including a second side substrate according to an example.

FIG. 8 is an exploded perspective view of a housing and a reflective module of a camera module according to an example.

FIGS. 9 and 10 are exploded perspective views of a housing and a lens module of a camera module according to an example.

Throughout the drawings and the detailed description, the same reference numerals refer to the same elements. The drawings may not be to scale, and the relative size, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

The drawings may not be to scale, and the relative sizes, proportions, and depiction of elements in the drawings may be exaggerated for clarity, illustration, and convenience.

Hereinafter, various examples will be described in detail with reference to the drawings.

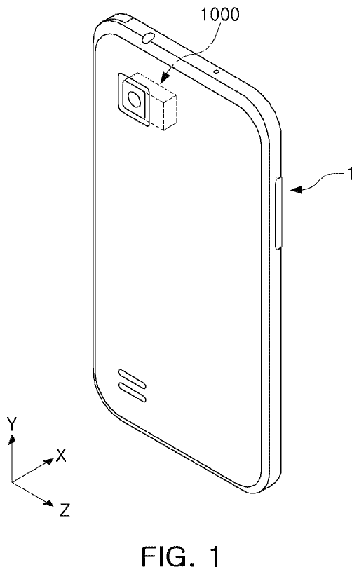

FIG. 1 is a perspective view of a portable electronic device in which a camera module 1000 according to an example is mounted.

Referring to FIG. 1, the camera module 1000 may be mounted on a portable electronic device 1. The portable electronic device 1 may be a portable electronic device, such as a mobile communication terminal, a smartphone, or a tablet PC.

As illustrated in FIG. 1, the portable electronic device 1 is equipped with the camera module 1000 to image a subject.

In the present example, the camera module 1000 includes a plurality of lenses. An optical axis (a Z-axis) of the plurality of lenses may be directed in a direction, perpendicular to a thickness direction (an X-axis direction) of the portable electronic device 1, a direction from a front surface to a rear surface of the portable electronic device 1, or the opposite direction.

For example, the optical axis (the Z-axis) direction of the plurality of lenses provided in the camera module 1000 may be formed in a width direction or a length direction of the portable electronic device 1.

Therefore, even if the camera module 1000 has functions, such as auto-focusing (AF), optical zoom (hereinafter referred to as zoom), and optical image stabilization (OIS), a thickness of the portable electronic device 1 may not increase. Accordingly, the portable electronic device 1 may be thinned.

The camera module 1000 may include at least one of the AF, zoom, and OIS functions.

Since the camera module 1000 having the AF, zoom, and OIS functions has to be provided with various parts, a size of the camera module 1000 increases, compared to a general camera module.

The increase in the size of the camera module 1000 may cause a problem in miniaturization of the portable electronic device 1 in which the camera module 1000 is mounted.

For example, the camera module 1000 may include a plurality of lenses for the zoom function. When the plurality of lenses is disposed in the thickness direction of the portable electronic device 1, the thickness of the portable electronic device 1 may also increase.

However, since the optical axis (the Z-axis) direction of the plurality of lenses is disposed, perpendicular to the thickness direction of the portable electronic device 1, in the camera module 1000, the portable electronic device 1 may be thinned although the camera module 1000 having the AF, zoom and OIS functions is mounted therein.

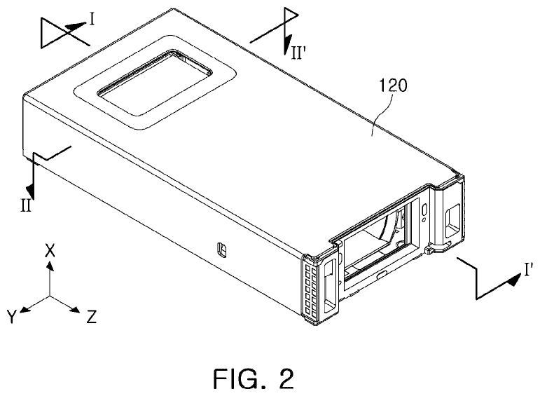

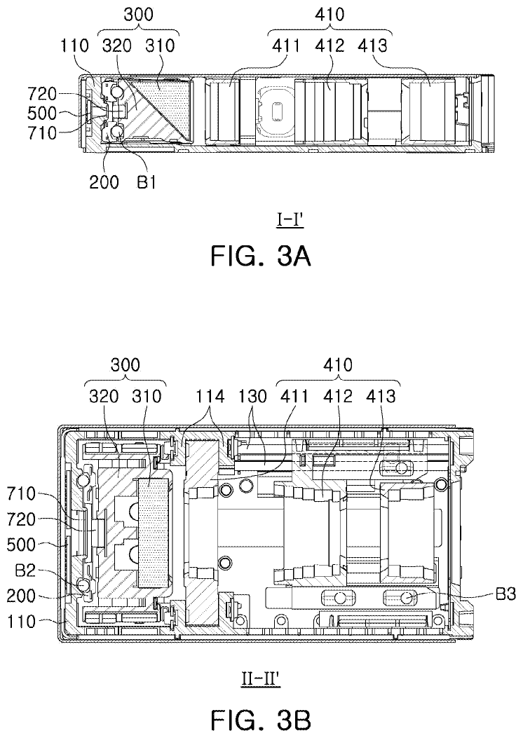

FIG. 2 is a schematic perspective view of the camera module 1000 according to an example, and FIG. 3A is a cross-sectional view taken along line I-I′ of FIG. 2, and FIG. 3B is a cross-sectional view taken along line II-II′ of FIG. 2.

Referring to FIGS. 2, 3A and 3B, the camera module 1000 may include a housing 110, a reflective module 300, a lens module 410, an image sensor module, and a case 120, and an example in which the reflective module 300 and the lens module 410 are disposed inside the housing 110 is illustrated.

The reflective module 300, the lens module 410, and the image sensor module may be arranged inside the housing 110 from one side toward the other. The housing 110 has an internal space to accommodate the reflective module 300, the lens module 410, and the image sensor module. However, the image sensor module may be attached to the outside of the housing 110.

The case 120 may be coupled to the housing 110 to cover an upper portion of the housing 110. The case 120 may have an opening through which light is incident. Light incident through the opening of the case 120 may be changed in a traveling direction by the reflective module 300 to be incident on the lens module 410.

The reflective module 300 is configured to change a traveling direction of light. For example, the traveling direction of light incident into the housing 110 may be changed to be directed toward the lens module 410 through the reflective module 300.

The reflective module 300 may include a reflective member 310 and a holder 320 on which the reflective member 310 is mounted.

The reflective member 310 is configured to change the traveling direction of light. For example, the reflective member 310 may be a prism or a mirror reflecting light.

A path of light incident through the opening of the case 120 may be changed toward the lens module 410 by the reflective module 300. For example, the path of light incident in the thickness direction of the camera module 1000 may be changed to approximately coincide with the optical axis (the Z-axis) direction by the reflective module 300.

The lens module 410 includes a plurality of lenses through which light changed in the traveling direction by the reflective member 300 passes and a lens barrel accommodating the plurality of lenses.

The image sensor module may include an image sensor and a printed circuit board.

The image sensor may be connected to the printed circuit board by a bonding wire.

The image sensor module may further include an infrared cut-off filter. The infrared cut-off filter may be attached to the housing 110. The infrared cut-off filter may block light within an infrared region in light passing through the lens module 410.

Based on the lens module 410, the reflective module 300 may be disposed in front of the lens module 410, and the image sensor module may be disposed at the rear of the lens module 410.

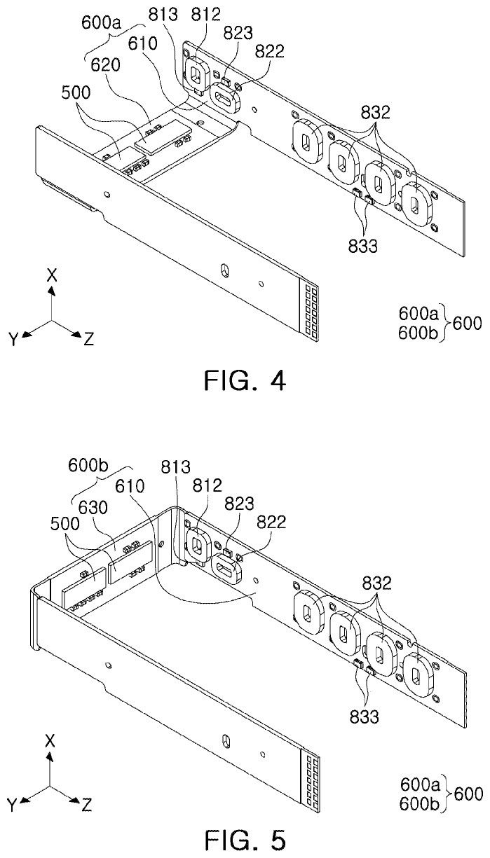

Referring also to FIGS. 4-8, a driving unit may be provided to move the reflective module 300. For example, the camera module 1000 may include a first driving unit 810 and a second driving unit 820 rotating the reflective module 300 along a first axis (the X-axis) and a second axis (a Y-axis), perpendicular to the optical axis (a Z-axis) within the housing 110. In addition, a first position detection sensor 813 and a second position detection sensor 823 detecting a position of the reflective module 300 may be provided.

A driving unit may be provided to move the lens module 410 in the optical axis (the Z-axis) direction. For example, the camera module 1000 may include a third driving unit 830 to move the lens module 410 in the optical axis (the Z-axis) direction within the housing 110. In addition, a third position detection sensor 833 detecting a position of the lens module 410 may be provided.

The first driving unit 810 may include a first magnet 811 and a first coil 812, and the second driving unit 820 may include a second magnet 821 and a second coil 822. The third driving unit 830 may include a third magnet 831 and a third coil 832.

FIG. 4 is a perspective view of a main substrate 600a including a bottom substrate 620 provided in the camera module, and FIG. 5 is a perspective view of a main substrate 600b including a second side substrate 630 provided in the camera module 1000 according to another example.

The main substrate 600 may be the main substrate 600a including a first side substrate 610 and the bottom substrate 620 as illustrated in FIG. 4, or may be the main substrate 600b including the first side substrate 610 and the second side substrate 630 as illustrated in FIG. 5.

Referring to FIG. 4, the main substrate 600a provided in the camera module 1000 may include the first side substrate 610 and the bottom substrate 620. The first side substrate 610 may include a surface, perpendicular to the second axis (the Y-axis), and the bottom substrate 620 may include a surface, parallel to the optical axis (the Z-axis), that is, a surface, perpendicular to the first axis (the X-axis).

A plurality of coils may be mounted on the first side substrate 610, and a circuit element 500 (a driver IC) providing a driving signal to the plurality of coils may be disposed on the bottom substrate 620. In addition, the main substrate 600a may be provided with a gyro sensor detecting a shaking factor, such as a user's hand-shake.

The plurality of coils may be disposed to face the internal space of the housing 110 on the first side substrate 610, and all of the plurality of coils may be disposed on the first side substrate 610. Accordingly, an empty space may be formed in the bottom substrate 620. At this time, the circuit element 500 may be disposed to face the internal space of the housing 110 on the bottom substrate 620.

Two first side substrates 610 may be provided to be symmetrical to each other with respect to the optical axis (the Z-axis) to face each other. Accordingly, the plurality of coils disposed on the first side substrate 610 may also be provided to be symmetrical to each other with respect to the optical axis (the Z-axis) to face each other. The two first side substrates 610 facing each other may be connected to the bottom substrate 620. The circuit element 500 may be provided on the connected bottom substrate 620, and transmit a driving signal to a plurality of coils disposed on the first side substrate 610. A plurality of circuit elements 500 may be provided to provide a driving signal to each of the first side substrates 610, and may be disposed to be symmetrical to each other with respect to the center of the bottom substrate 620.

Since a plurality of coils may be disposed on the first side substrate 610, the circuit elements 500 may be disposed near the center of the bottom substrate 620, rather than the side surface, to be symmetrical to the center of the bottom substrate 620, so that the circuit elements 500 may not be in contact with the plurality of coils. That is, by disposing the circuit element 500 near the center of the bottom substrate 620, space utilization may be increased and the AF, zoom, and OIS related patterns may be applied to the first side substrate 610.

Referring to FIG. 5, the main substrate 600b provided in the camera module 1000 may include the first side substrate 610 and the second side substrate 630. The first side substrate 610 may include a surface, perpendicular to the second axis (the Y-axis), and the second side substrate 630 may include a surface, perpendicular to the optical axis (the Z-axis).

The plurality of coils may be disposed to face the internal space of the housing 110 on the first side substrate 610, and all of the plurality of coils may be disposed on the first side substrate 610. Accordingly, an empty space may be formed in the second side substrate 630. At this time, the circuit element 500 may be disposed to face the internal space of the housing 110 on the second side substrate 630. That is, the circuit element 500 may be disposed in a region, perpendicular to the optical axis (the Z-axis).

Two first side substrates 610 may be provided to be symmetrical to each other with respect to the optical axis (the Z-axis) to face each other. Accordingly, the plurality of coils disposed on the first side substrate 610 may also be provided to be symmetrical to each other with respect to the optical axis (the Z-axis) to face each other. The two first side substrates 610 facing each other may be connected to the second side substrate 630. The circuit element 500 may be provided on the connected second side substrate 630, and transmit a driving signal to a plurality of coils disposed on the first side substrate 610. A plurality of circuit elements 500 may be provided to provide a driving signal to each of the first side substrates 610, and may be disposed to be symmetrical to each other with respect to the center of the second side substrate 630.

Since a plurality of coils may be disposed on the first side substrate 610, the circuit elements 500 may be disposed near the center of the second side substrate 630, rather than the side surface, to be symmetrical to the center of the second side substrate 630, so that the circuit elements 500 may not be in contact with the plurality of coils. That is, by disposing the circuit element 500 near the center of the second side substrate 630, space utilization may be increased and the AF, zoom, and OIS related patterns may be applied to the first side substrate 610.

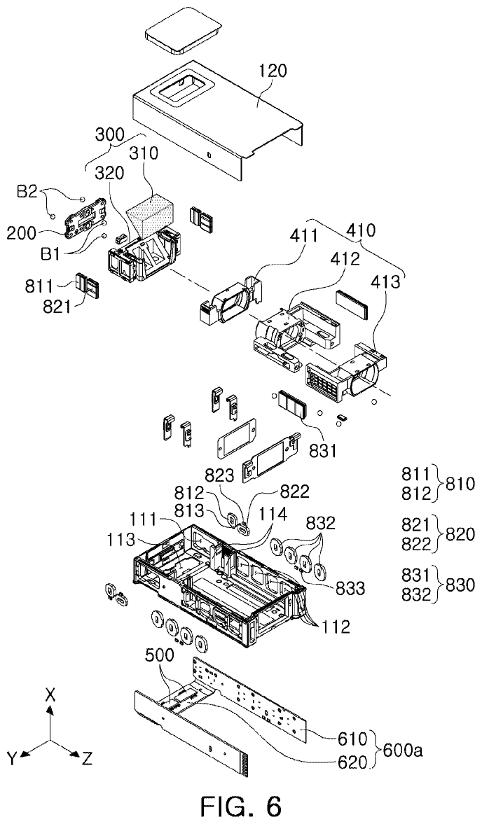

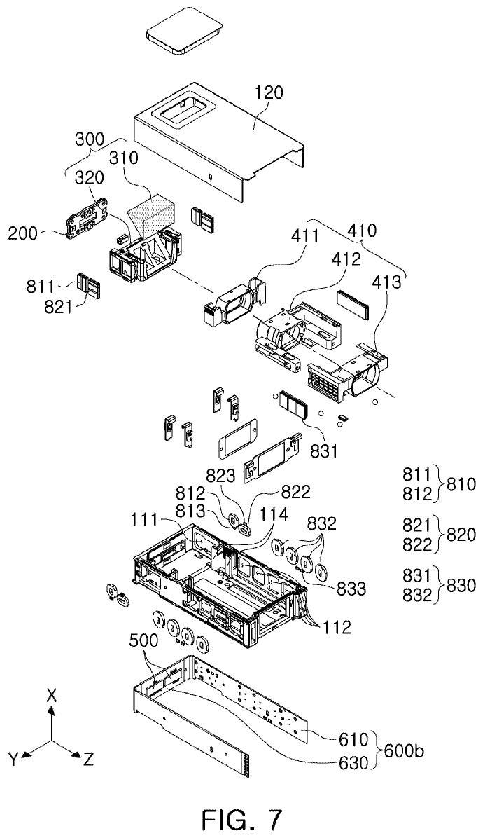

FIGS. 6 and 7 are schematic exploded perspective views of the camera module 1000.

FIG. 6 is an exploded perspective view of a camera module 1000 including the main substrate 600a including the bottom substrate 620, and FIG. 7 is an exploded perspective view of the camera module 1000 including the main substrate 600b including the second side substrate 630.

Referring to FIG. 6, the circuit element 500 and the first coil 812 to the third coil 832 may be disposed to face the internal space of the housing 110 on the main substrate 600a. For example, the circuit element 500 may be disposed on one surface of the bottom substrate 620 facing the reflective module 300 in the first axis (the X-axis) direction, and the first coil 812, the second coil 822, and the third coil 832 may be disposed on one surface of the first side substrate 610. That is, the circuit element 500 may be disposed in a region facing the reflective module 300. In addition, a plurality of circuit elements 500 may be provided and arranged to be symmetrical to each other with respect to the center of the bottom substrate 620 along the second axis (the Y-axis).

Similarly, referring to FIG. 7, the circuit element 500 and the first coil 812 to the third coil 832 may be disposed to face the internal space of the housing 110 on the main substrate 600b. For example, the circuit element 500 may be disposed on one surface of the second side substrate 630 facing the reflective module 300 in the optical axis (the Z-axis) direction, and the first coil 812, the second coil 822, and the third coil 832 may be disposed on one surface of the first side substrate 610. That is, the circuit element 500 may be disposed in a region facing the reflective module 300. In addition, a plurality of circuit elements 500 may be provided and arranged to be symmetrical to each other with respect to the center of the second side substrate 630 along the second axis (the Y-axis).

The main substrate 600 may be attached to an outer surface of the housing 110 by bonding using an adhesive. The first side substrate 610 may be attached to one side surface of the housing 110, and the second side substrate 630 may be attached to the other side surface of the housing 110. Also, the bottom substrate 620 may be attached to a bottom portion of the housing 110.

Since a plurality of coils may be mounted on the first side substrate 610, a through-hole may exist in the housing 110 to correspond to the plurality of coils. Similarly, since the circuit element 500 may be disposed to face the internal space of the housing 110 on the bottom substrate 620, a through-hole corresponding to the circuit element 500 may exist in the housing 110. In an example, the housing 110 may include a first through-hole 111 in which the first coil 812 and the second coil 822 are disposed, a second through-hole 112 in which the third coil 832 is disposed, and a third through-hole 113 in which the circuit element 500 is disposed. Accordingly, the first through-hole 111 and the second through-hole 112 may be provided on one side surface of the housing 110, and the third through-hole 113 may be provided on the other side surface or bottom portion of the housing 110.

The reflective module 300 and the lens module 410 are disposed in the internal space of the housing 110. The housing 110 may include a protrusion wall 114. For example, the protrusion wall 114 may protrude from both inner surfaces of the housing 110. A plurality of protrusion walls 114 may be provided, and the lens barrel 411 of the lens module 410 may be provided between the protrusion walls 114.

When one protrusion wall 114 is provided, the internal space of the housing 110 may be divided into a space in which the reflective module 300 is disposed and a space in which the lens module 410 is disposed by the protrusion wall 114. For example, the reflective module 300 may be disposed in front of the protrusion wall 114, and the lens module 410 may be disposed at the rear thereof.

When a plurality of protrusion walls 114 are provided, a space in which the lens barrel 411 is disposed may exist between adjacent protrusion walls 114. That is, the lens barrel 411 may be fixed through the protrusion wall 114. In addition, the reflective module 300 may be disposed in front of the fixed lens barrel 411, and other lens barrels 412 and 413 may be disposed at the rear side.

The reflective module 300 may be disposed in the internal space of the housing 110 and may be pulled toward the housing 110. For example, a magnetic material may be disposed on the housing 110 and the reflective module 300, and accordingly, the reflective module 300 may be pulled toward the inner surface of the housing 110. For example, a pulling yoke 710 may be disposed on any one of the housing 110 and the reflective module 300, and a pulling magnet 720 may be disposed on the other to face the pulling yoke 710 in the optical axis (the Z-axis) direction. Accordingly, the pulling yoke 710 and the pulling magnet 720 may generate attractive force in the optical axis (the Z-axis) direction, so that the reflective module 300 may be pressed toward the housing 110.

In another example, the pulling magnet 720 may be disposed at each of the housing 110 and the reflective module 300.

A guide member 200 may be disposed in front of the reflective module 300. The guide member 200 is disposed between an inner surface of the housing 110 and the reflective module 300. For example, the guide member 200 may be disposed between the inner surface of the housing 110 on which the pulling yoke 710 is disposed and the reflective module 300 on which the pulling magnet 720 is disposed.

The guide member 200 may have a plate-like shape and may have a through-hole so that the pulling yoke 710 and the pulling magnet 720 may directly face each other. A first ball member B1 may be disposed between the guide member 200 and the reflective module 300, and a second ball member B2 may be disposed between the guide member 200 and the housing 110.

The first ball member B1 may include a plurality of ball members spaced apart from each other along the first axis (the X-axis), and the second ball member B2 may include a plurality of ball members spaced apart from each other along the second axis (the Y-axis).

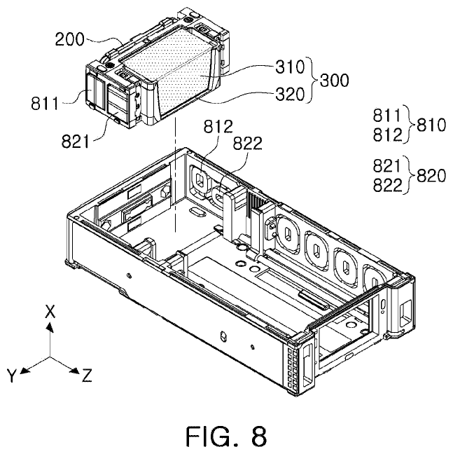

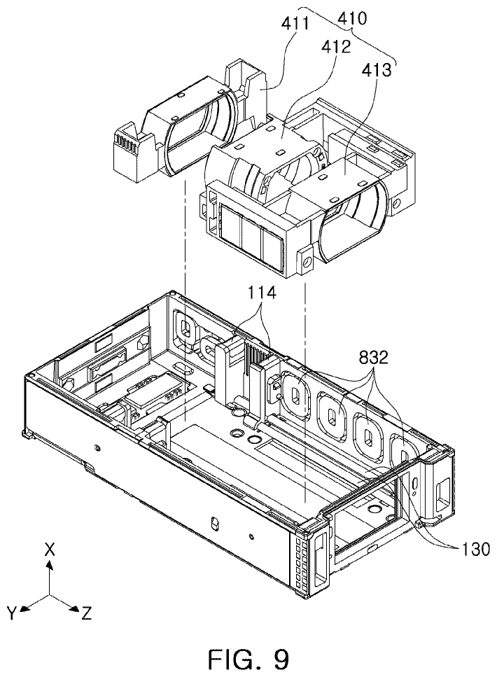

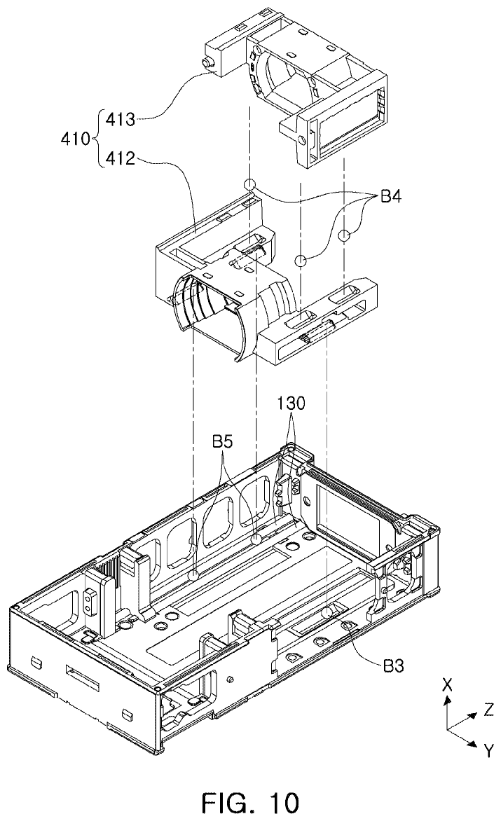

FIG. 8 is an exploded perspective view of the housing 110 and the reflective module 300 of the camera module 1000 according to an example, and FIGS. 9 and 10 are exploded perspective views of the housing 110 and the lens module 410 of the camera module 1000 according to an example.

Referring to FIG. 8, the first driving unit 810 may generate driving force so that the holder 320 is rotatable based on the first axis (the X-axis), and the second driving unit 820 may generate driving force so that the holder 320 is rotatable based on the second axis (the Y-axis).

For example, the first driving unit 810 may include the first magnet 811 and the first coil 812 disposed to face the first magnet 811.

The first magnet 811 may be attached to the reflective module 300. For example, the first magnet 811 is disposed on a side surface of the holder 320. The first magnet 811 may include a plurality of magnets arranged on both side surfaces (i.e., an X-Y plane) of the holder 320.

The first coil 812 may be disposed to face the first magnet 811. The first coil 812 may be disposed on the first side substrate 610 of the main substrate 600. The first coil 812 may also include a plurality of coils to correspond to the first magnet 811.

The first coil 812 and the first magnet 811 generate electromagnetic force in a direction, perpendicular to a direction in which the first coil 812 and the first magnet 811 face each other. For example, the first magnet 811 and the first coil 812 may be disposed to face each other in the second axis (the Y-axis) direction, and may generate driving force in the optical axis (the Z-axis) direction. Since the first ball member B1 may be disposed between the guide member 200 and the reflective module 300 in the first axis (the X-axis) direction, the driving force generated in the optical axis (the Z-axis) direction may rotate the reflective module 300 based on the first axis (the X-axis) as a rotation axis.

For example, the second driving unit 820 may also include the second magnet 821 and the second coil 822 disposed to face the second magnet 821.

The second magnet 821 may be attached to the reflective module 300. For example, the second magnet 821 is disposed on a side surface of the holder 320. The second magnet 821 may include a plurality of magnets disposed on both side surfaces (i.e., the X-Y plane) of the holder 320.

The second coil 822 may be disposed to face the second magnet 821. The second coil 822 may be disposed on the first side substrate 610 of the main substrate 600. The second coil 822 may also include a plurality of coils to correspond to the second magnet 821.

The second coil 822 and the second magnet 821 generate electromagnetic force in a direction, perpendicular to a direction in which the second coil 822 and the second magnet 821 face each other. For example, the second magnet 821 and the first coil 822 may be disposed to face each other in the second axis (the Y-axis) direction, and may generate driving force in the first axis (the X-axis) direction. Since the second ball member B2 may be disposed between the housing 110 and the guide member 200 in the second axis (the Y-axis) direction, driving force generated in the first axis (the X-axis) direction may rotate the reflective module 300 based on the second axis (the Y-axis) as a rotation axis.

In the present example, when the holder 320 is rotated, a closed-loop control method of detecting and feedbacking a position of the holder 320 may be used.

Accordingly, the first position detection sensor 813 and the second position detection sensor 823 may be provided to detect a position of the reflective module 300.

The first position detection sensor 813 may be disposed on the main substrate 600, and may be disposed to face the first magnet 811. The second position detection sensor 823 may be disposed on the main substrate 600, and may be disposed to face the second magnet 821.

Referring to FIGS. 9 and 10, the lens module 410 may be provided in the internal space of the housing 110 to be movable in the optical axis (the Z-axis) direction, and may include a plurality the lens barrels 411, 412, and 413. For example, the lens barrel 410 may include a first lens barrel 411, a second lens barrel 412, and a third lens barrel 413.

Some of the plurality of lens barrels may be maintained to be fixed to the protrusion wall 114, and the others may be movable along the optical axis (the Z-axis) by the third driving unit 830. For example, the first lens barrel 411 may be fixed by the plurality of protrusion walls 114, and the second lens barrel 412 and the third lens barrel 413 may be movable by the third driving unit 830.

The third driving unit 830 generates driving force so that the plurality of lens barrels move in the optical axis (the Z-axis) direction. The third driving unit 830 may include the third magnet 831 and the third coil 832.

The third magnet 831 may be mounted on one of the lens barrels. For example, the third magnet 831 may be disposed on a side surface of the third lens barrel 413.

The third coil 832 may be disposed to face the third magnet 831 in a direction, perpendicular to the optical axis (the Z-axis) direction. For example, the third coil 832 may be disposed on the first side substrate 610, and the housing 110 may have a through-hole through which the third coil 832 is disposed. Accordingly, the third coil 832 may be disposed to face the third magnet 831 in the second axis (the Y-axis) direction.

In the present example, a closed-loop control method of detecting and feedbacking a position of the lens module 410 may be used. Accordingly, the third position detection sensor 833 may be provided to detect the position of one or more of the lens barrels 411, 412, and 413. Since a plurality of lens barrels may be provided, a plurality of third position detection sensors 833 may also be provided to correspond to the lens barrels. The third position detection sensor 833 may be disposed on the main substrate 600, and may be disposed to face the third magnet 831.

Referring to FIG. 10, the second lens barrel 412 may be guided by a shaft 130 to move in the optical axis (the Z-axis) direction.

The shaft 130 may be fixed to the housing 110, and a plurality of shafts 130 may be provided. A guide ball member B5 may be disposed at an upper portion of the plurality of shafts 130, and the guide ball member B5 may move in a rolling manner along the upper portion of the shaft 130.

A groove portion in which the guide ball member B5 may be disposed may be provided at a lower end of one side surface of the second lens barrel 412. Accordingly, the guide ball member B5 may be disposed at the lower end of one side surface of the second lens barrel 412, and the guide ball member B5 may be disposed between the plurality of shafts 130 to move in a rolling manner at the upper portion of the shaft 130.

The shaft 130 may be disposed on one side of the bottom surface of the housing 110, and a groove portion may be provided at a lower end of the other side surface of the second lens barrel 412 so that a third ball member B3 may be disposed. A corresponding groove portion may be provided on the other side of the bottom surface of the housing 110, and the third ball member B3 may be movable in the optical axis (the Z-axis) direction along the groove portion. Accordingly, the second lens barrel 412 is movable in the optical axis (the Z-axis) direction along the third ball member B3 and the guide ball member B5.

The third lens barrel 413 may be integrally movable in combination with the second lens barrel 412. For example, a fourth ball member B4 may be provided between the third lens barrel 413 and the second lens barrel 412. Groove portions may be provided at a lower end of the third lens barrel 413 and an upper end of the second lens barrel 412 to correspond to each other, and the fourth ball member B4 may be disposed along the groove portion to be movable along the optical axis (the Z-axis). Accordingly, the third lens barrel 413 may be disposed on the second lens barrel 412 and may be movable together, or only the third lens barrel 413 may be individually movable through the fourth ball member B4.

As set forth above, the camera module according to the various examples discussed herein may have a reduced size and may reduce a unit price through the simplification of a manufacturing process of the main substrate.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing defining an internal space;
a lens module including a plurality of lenses disposed along an optical axis;
a reflective module disposed in front of the lens module and including a reflective member configured to change an optical path of light;
a first driving unit configured to rotate the reflective module and including a first coil and a first magnet;
a second driving unit configured to rotate the reflective module and including a second coil and a second magnet;
a main substrate attached to the housing and including a first side substrate; and
a circuit element disposed on the main substrate and configured to provide a driving signal,
wherein the first coil and the second coil are disposed on the first side substrate of the main substrate, and
the circuit element is disposed on a surface of the main substrate that is perpendicular to the first side substrate, and the circuit element faces the internal space of the housing.

2. The camera module of claim 1, wherein the circuit element is disposed to face the reflective module.

3. The camera module of claim 1, wherein the circuit element includes a plurality of circuit elements.

4. The camera module of claim 1, further comprising:
a third driving unit including a third coil and a third magnet configured to drive the lens module,
wherein the third coil is disposed on the first side substrate, and
the lens module includes a first lens barrel and a second lens barrel.

5. The camera module of claim 4, further comprising:
a plurality of shafts coupled to the housing and disposed along the optical axis direction,
wherein the first lens barrel is configured to move in the optical axis direction along the shafts.

6. The camera module of claim 5, further comprising:
a guide ball member disposed between the shafts and the first lens barrel,
wherein the guide ball member is configured to move in a rolling manner between the plurality of shafts.

7. The camera module of claim 6, wherein the second lens barrel is coupled to the first lens barrel and configured to be integrally movable with the first lens barrel.

8. The camera module of claim 7, further comprising:
a rolling ball member disposed between the first lens barrel and the second lens barrel,
wherein the second lens barrel is movable above the first lens barrel along the rolling ball member.

9. The camera module of claim 1, wherein
the main substrate includes a bottom substrate having a surface parallel to the optical axis, and
the circuit element is disposed on the bottom substrate.

10. The camera module of claim 9, wherein the circuit element includes a plurality of circuit elements, and the plurality of circuit elements are symmetrical with respect to a center of the bottom substrate.

11. The camera module of claim 1, wherein
the main substrate includes a second side substrate having a surface perpendicular to the optical axis, and
the circuit element is disposed on the second side substrate.

12. The camera module of claim 11, wherein the circuit element includes a plurality of circuit elements, and the plurality of circuit elements are symmetrical with respect to a center of the second side substrate.

13. A camera module comprising:
a housing;
a lens module disposed in the housing and including a plurality of lenses arranged along an optical axis;
a reflective module disposed in front of the lens module and including a reflective member configured to change an optical path of light;
a main substrate attached to the housing; and
a circuit element disposed on the main substrate and configured to provide a driving signal,
wherein the circuit element is disposed to face the reflective module, and
the housing has a through-hole corresponding to the circuit element.

14. The camera module of claim 13, wherein the circuit element is disposed perpendicular to the optical axis.

15. The camera module of claim 14, wherein the circuit element includes a plurality of circuit elements.
